(19) United States
(12) Patent Application Publication
(10) Pub. No.: US 2020/0352817 A1
(43) Pub. Date: Nov. 12, 2020

(54) DEVICES AND METHODS FOR GENERATING PERIODIC MOVEMENTS OF A SKIN

(71) Applicant: N.M.B. MEDICAL APPLICATIONS LTD, Herzliya (IL)

(72) Inventors: Mordechay BEYAR, Tel Aviv (IL); Oren GLOBERMAN, Kfar-Shmaryahu (IL)

(73) Assignee: N.M.B. MEDICAL APPLICATIONS, Herzliya (IL)

(21) Appl. No.: 16/767,246

(22) PCT Filed: Nov. 28, 2018
(86) PCT No.: PCT/IL2018/051300

§ 371 Date: May 27, 2020

Related U.S. Application Data
(60) Provisional application No. 62/591,224, filed on Nov. 28, 2017.

(51) Int. Cl. A61H 9/00

(52) U.S. Cl. CPC A61H 9/0057; A61H 9/0071; A61H 2201/5056; A61H 2201/1409; A61H 2201/0153

(57) ABSTRACT

Generally, devices and methods for accelerating/decelerating a skin are disclosed. The method may include applying an applicator to a selected location on the skin, and periodically and mechanically moving/displacing the skin by the applicator according to a specified acceleration/deceleration pattern and at specified acceleration/deceleration values

### FIELD OF THE INVENTION

The present invention relates to the field of devices and methods for generating periodic movements of a skin, and more particularly, to devices and methods for generating mechanical periodic movements of a skin.

### BACKGROUND OF THE INVENTION

Current devices and methods for rejuvenation of a skin typically utilize injection of tissue fillers, cold trauma (such as multi-needle puncturing of the skin, massaging of the skin, chemical peeling of the skin, etc.) and hot trauma (such as laser, radio-frequency, focused ultrasound, etc.) to rejuvenate the skin. However, application of the devices and methods thereof may be painful and may require an anesthetizing the zone of treatment.

### SUMMARY OF THE INVENTION

One aspect of the present invention provides a method of generating periodic movements of a skin, the method may include: applying an applicator to a selected location on the skin, and periodically and mechanically moving/displacing the skin by the applicator according to a specified acceleration/deceleration pattern and at specified acceleration/deceleration values ranging between 100-6000 m/sec².

Another aspect of the present invention provides a device for generating periodic movements of a skin, the device may include: an applicator attachable to a selected location on the skin; a mechanical movements generator coupled to the applicator and arranged to periodically and mechanically move/displace the skin using the applicator and according to a specified acceleration/deceleration pattern and at specified acceleration/deceleration values ranging between 100-6000 m/sec²; and a controller coupled to the mechanical movements generator and configured to control the mechanical movements/displacements of the skin by the applicator.

Another aspect of the present invention provides a method of a rejuvenation of a skin, the method may include mechanically and periodically moving/displacing a selected location on an external surface of a skin according to a specified acceleration/deceleration pattern and at specified acceleration/decelerations values without damaging an external surface of the skin, wherein the specified acceleration/deceleration pattern and the specified acceleration/decelerations values are configured at least to initiate induction of collagen and/or induction of the skin to thereby induce the rejuvenation of the skin.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1A is a schematic block diagram of a device for generating periodic movements of a skin, according to some embodiments of the invention;

FIGS. 1B, 1C and 1D are schematic illustrations of different movements/displacements patterns of a skin generatable by a device for generating periodic movements of a skin, according to some embodiments of the invention;

FIG. 2A is a schematic illustration of a device for generating periodic movements of a skin and including a pressure generator, according to some embodiments of the invention;

FIGS. 2B, 2C, 2D, 2E, 2F and 2G are graphs showing various predetermined pressure patterns providable by a pressure generator of a device for generating periodic movements of a skin, according to some embodiments of the invention;

FIG. 3A is a schematic illustration of an example of operation of device for generating periodic movements of a skin and including a pressure generator, according to some embodiments of the invention;

FIGS. 3B, 3C and 3D are schematic illustrations of damage causable to skin layers below a surface of the skin by a device for generating periodic movements of skin, according to some embodiments of the invention;

FIGS. 4A and 4B are schematic illustrations of a device for generating periodic movements of a skin and including a vacuum pump with a valve assembly, according to some embodiments of the invention;

FIGS. 4C and 4D are schematic illustrations of a more detailed aspect of a device for generating periodic movements of a skin and including a valve assembly, according to some embodiments of the invention;

FIGS. 4E, 4F, 4G and 4H are schematic illustrations of different operational positions of a valve assembly during an operational cycle of a device for generating periodic movements of a skin, according to some embodiments of the invention;

FIGS. 5A, 5B, 5C and 5D are schematic illustrations of a device for generating periodic movements of a skin and including a pressure generator with a movable piston assembly, according to some embodiments of the invention;

FIGS. 5E, 5F and 5G are schematic illustrations of a device for generating periodic movements of a skin and including a pressure generator with a diaphragm assembly, according to some embodiments of the invention;

FIG. 6 is a schematic illustration of an applicator for a device for generating periodic movements of a skin, according to some embodiments of the invention;

FIG. 7 is a schematic illustration of a device for generating periodic movements of a skin and including a mechanical movements assembly, according to some embodiments of the invention;

FIG. 8 is a flowchart of a method of generating periodic movements of a skin, according to some embodiments of the invention; and

FIG. 9 is a flowchart of a method of a rejuvenation of a skin, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Generally, devices and methods for periodic and repeated movements of a skin are disclosed. It is noted that the term “skin” as used herein refers to a skin of a live body. The method may include applying an applicator to a selected location on the skin and periodically and mechanically causing the skin to move in directions that are perpendicular to the skin's surface, according to a specified acceleration/deceleration pattern and at specified acceleration/deceleration values ranging between, for example, 100-6000 m/sec². In various embodiments, the periodic and mechanical movements of the skin are achieved by a pressure generator (e.g., that includes a valve assembly or a movable piston assembly) or by a mechanical movements assembly.

The specified acceleration/deceleration patterns and/or the specified acceleration/deceleration values may be determined to, for example, generate periodic tension/compression forces within and/or between at least some of the layers of the skin. The periodic tension/compression forces may, for example, generate at least one of: formation of cavitation, formation of blisters, collapse of blisters, formation of tearing and/or formation of separations within and/or between at least some of the layers of the skin, to thereby damage at least a portion of the skin, without damaging (or substantially without damaging) the external surface of the skin. The damage thereof may, for example, cause controlled local inflammation and/or subsequent induction of collagen and/or induction of the skin, which may result in rejuvenation of the skin and/or in smoothing of wrinkles on the skin.

Advantageously, the disclosed devices and methods may enable non-invasive periodic movements of the skin without damaging (or substantially without damaging) the external surface of the skin. Furthermore, the disclosed devices and methods may enable non-invasive rejuvenation of the skin, while, for example, eliminating a need in painful thermal and/or chemical procedures of skin rejuvenation.

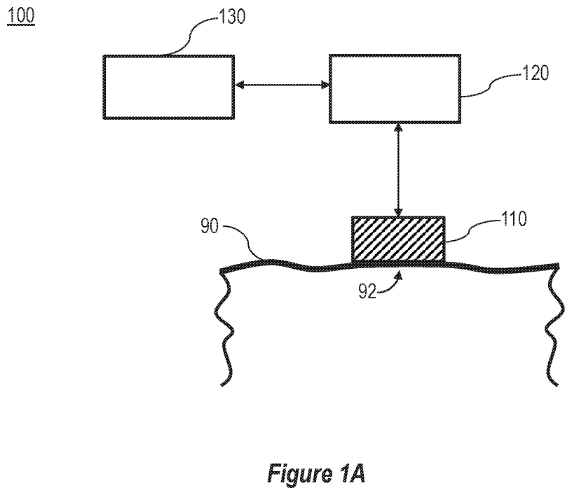

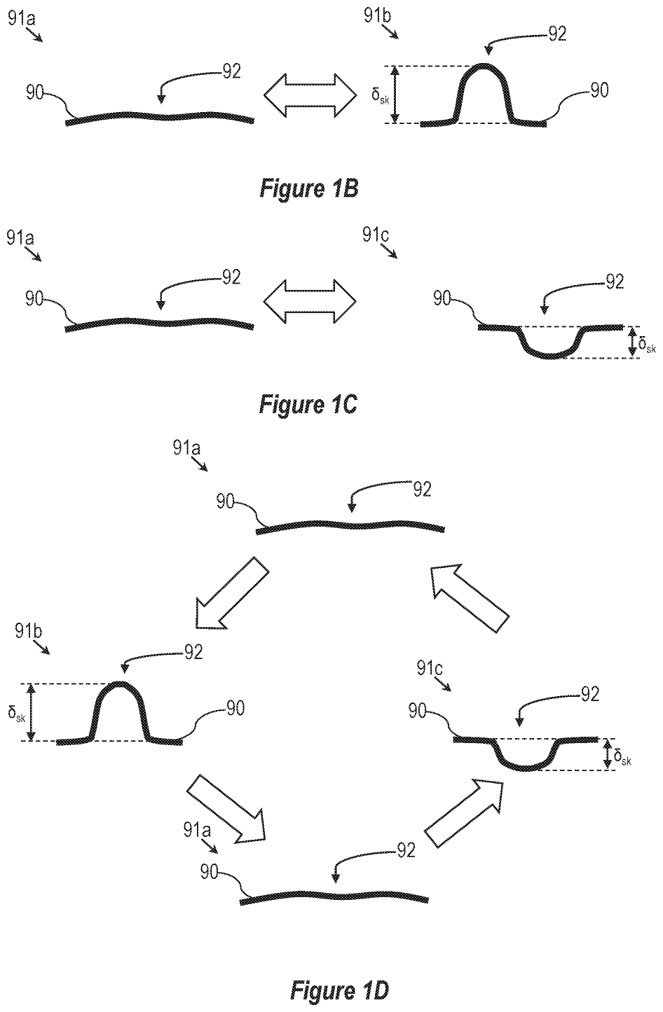

Reference is now made to FIG. 1A, which is a schematic block diagram of a device 100 for generating periodic movements of a skin 90, according to some embodiments of the invention.

According to some embodiments, device 100 includes an applicator 110, a mechanical movements generator 120 and a controller 130.

Applicator 110 may be attachable/applicable to a selected location 92 on an external surface of a skin 90.

Mechanical movements generator 120 may be coupled to applicator 110. Mechanical movements generator 120 may cause periodic mechanical movements of skin 90 (at least in vicinity of selected location 92) in directions that are perpendicular to the surface of skin 90, using applicator 110 and according to a specified acceleration/deceleration pattern and/or at specified acceleration/deceleration values. In some embodiments, the specified acceleration/deceleration values range between 100 m/sec² and 6000 m/sec².

Controller 130 may be coupled to mechanical movements generator 120. Controller 130 may control the mechanical movements generator 120 to thereby control the periodic movements of skin 90 by applicator 110.

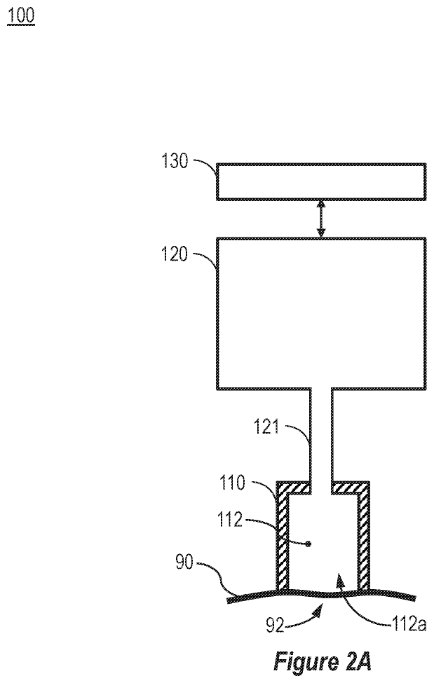

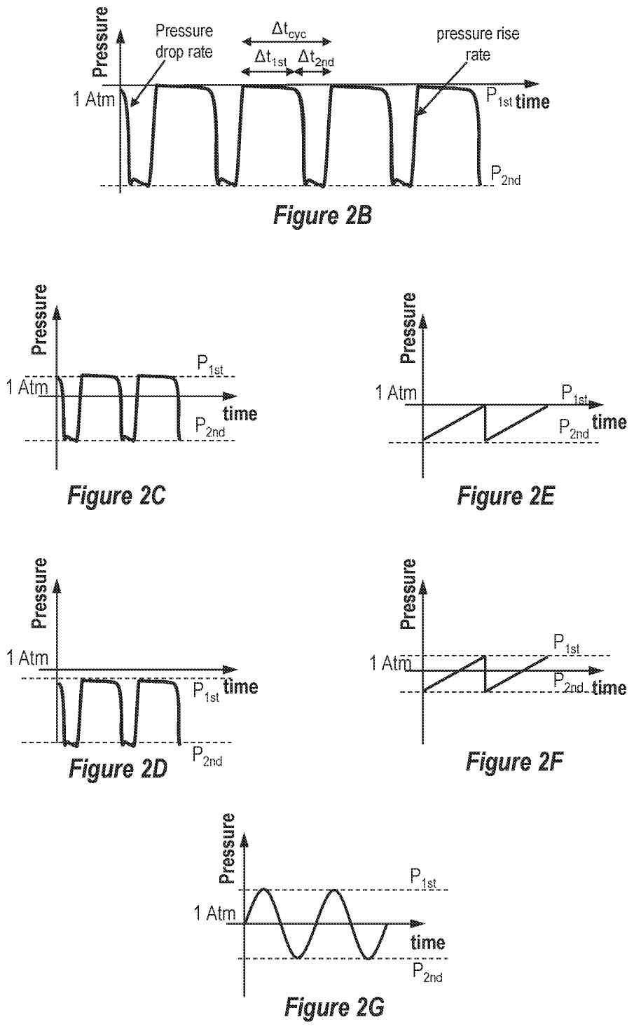

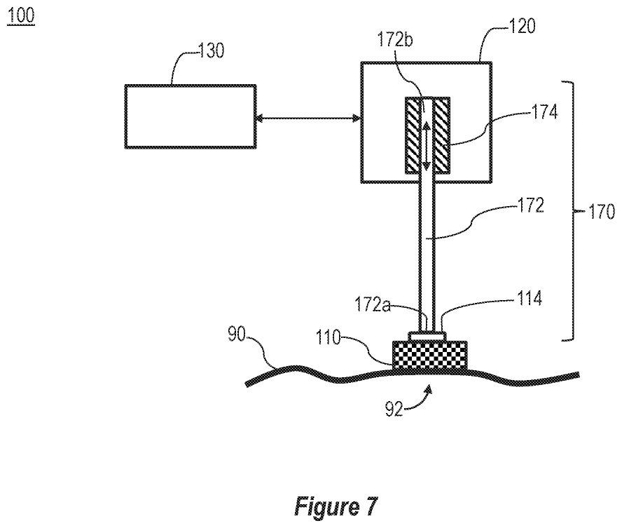

In various embodiments, mechanical movements generator 120 is a pressure generator (e.g., as described below with respect to FIGS. 2A, 3A, 4A-4H, 5A-5D and 5E-5G) or a mechanical movements assembly (e.g., as described below with respect to FIG. 7).

Reference is now made to FIGS. 1B, 1C and 1D, which are schematic illustrations of different movements/displacements patterns of a skin 90, generatable by a device 100 for generating periodic movements of a skin 90, according to some embodiments of the invention.

According to some embodiments, mechanical movements generator 120 periodically moves/displaces (e.g., using applicator 110) skin 90 (e.g., at least in vicinity of selected location 92) between an initial position 91a and a pulled position 91b, by pulling skin 90 at selected location 92 away from the surface of skin 90 (e.g., as shown in FIG. 1B). It is noted that applicator 110 and mechanical movements generator 120 are not shown in FIGS. 1B, 1C and 1D, but are described above with respect to FIG. 1A.

According to some embodiments, mechanical movements generator 120 periodically moves/displaces skin 90 (e.g., using applicator 110) between an initial position 91a and a pushed position 91c, by pushing skin 90 at selected location 92 into skin tissue 90 (e.g., as shown in FIG. 1C).

According to some embodiments, mechanical movements generator 120 periodically moves/displaces skin 90 (e.g., using applicator 110) between pulled position 91b and pushed position 91c (through initial position 91a) (e.g., as shown in FIG. 1D).

According to some embodiments, the magnitude of periodic displacement/movement of skin 90 (indicated in FIGS. 1B, 1C and 1D as δₛₖ) ranges between 1 mm and 10 mm

Reference is now made to FIG. 2A, which is a schematic illustration of a device 100 for generating periodic movements of a skin 90 and including a pressure generator 120, according to some embodiments of the invention.

According to some embodiments, mechanical movements generator 120 is a pressure generator. In these embodiments, applicator 110 includes a cavity 112. Cavity 112 may include a cavity opening 112a that may be applicable to skin 90 when applicator 110 is applied thereto (e.g., as shown in FIG. 2A).

Pressure generator 110 may be in a fluid communication 121 with applicator 110/cavity 112. Pressure generator 120 may be arranged to generate the periodic mechanical movements of skin 90 by providing a pressure to applicator 110/cavity 112 and oscillating the pressure thereof according to a predetermined pressure pattern (e.g., as described below with respect to FIGS. 2B-2G).

In various embodiments, the predetermined pressure pattern is determined to provide the specified acceleration/deceleration pattern of periodic movement/displacement of skin 90 (e.g., as described above with respect to FIG. 1A).

In some embodiments, pressure generator 120 alternately and periodically changes the pressure provided to applicator 110/cavity 112 between a first pressure value and a second pressure value at a predetermined pressure drop rate and between the second pressure value and the first pressure value at a predetermined pressure rise rate (e.g., as described below with respect to FIGS. 2B-2G).

In various embodiments, the pressure drop rate and/or the pressure rise rate are determined to provide the specified acceleration/deceleration values of skin 90.

Reference is now made to FIGS. 2B, 2C, 2D, 2E, 2F and 2G, which are graphs showing various predetermined pressure patterns providable by a pressure generator 120 of a device 100 for generating periodic movements of a skin 90, according to some embodiments of the invention.

According to some embodiments, pressure generator 120 provides oscillating pressure to applicator 110, according to the predetermined pressure pattern (e.g., as described above with respect to FIG. 2A).

Pressure generator 120 may oscillate the pressure provided to applicator 110/cavity 112 at a predetermined frequency. In some embodiments, the predetermined frequency ranges between 1 Hz and 60 Hz. In some embodiments, the predetermined frequency is 5 Hz.

According to some embodiments, pressure generator 120 may alternately and periodically change the pressure provided to applicator 110/cavity 112 between a first pressure value and a second pressure value and between the second pressure value and the first pressure value (e.g., as shown in FIGS. 2B, 2C, 2D, 2E, 2F and 2G). It is noted that the first pressure value and the second pressure value are indicated as P₁ₛₜ and P_{2nd}, respectively, in FIGS. 2A-2G.

In various embodiments, the first pressure value is larger than 1 Atm absolute (e.g., as shown in FIGS. 2C, 2F and 2G), smaller than 1 Atm absolute (e.g., as shown in FIG. 2C) or equals (or substantially equals) to 1 Atm absolute (e.g., as shown in FIGS. 2B and 2E). In some embodiments, the second pressure value is smaller than 1 Atm absolute (e.g., as shown in FIG. 2D). In some embodiments, the first pressure value ranges between 1 Atm absolute and 2 Atm absolute. In some embodiments, the second pressure value ranges between 0.1 Atm absolute and 0.9 Atm absolute.

According to some embodiments, pressure generator 120 provides oscillating pressure having various waveforms. For example, pressure generator 120 may provide oscillating pressure having a square (or substantially square) waveform (e.g., as shown in FIGS. 2B, 2C and 2D) a sawtooth (or substantially sawtooth) waveform (e.g., as shown in FIGS. 2E and 2F) and/or a sinusoidal (or substantially sinusoidal) waveform (e.g., as shown in FIG. 2G).

According to some embodiments, pressure generator 120 alternately and periodically changes the pressure provided to applicator 110 between the first pressure value and the second pressure value at the predetermined pressure drop rate and between the second pressure value and the first pressure value at the predetermined pressure rise rate.

For example, the pressure drop rate and the pressure rise rate may be defined by slopes of the graph in the intermediate regions between the first pressure value and the second pressure value and between the second pressure value and the first pressure value, respectively (e.g., as shown in FIG. 2A).

In various embodiments, the predetermined pressure drop rate and/or the predetermined pressure rise rate ranges between 60 Atm/sec and 600 Atm/sec. For example, the predetermined pressure drop rate and/or the predetermined pressure rise rate may be 160 Atm/sec.

In various embodiments, in each time period Δt_{cyc}, a time duration Δt₁ₛₜ during which pressure provided to applicator 110 has the first pressure value is smaller (e.g., as shown in FIG. 2A), equal (not shown) or larger (not shown) than a time duration Δt_{2nd} during which the provided pressure has the second pressure value. For example, Δt₁ₛₜ and Δt_{2nd} may be 50% of Δt_{cyc}. In another example, Δt₁ₛₜ may be 10% of Δt_{cyc} and Δt_{2nd} may be 90% of Δt_{cyc}.

It is noted that the movement/displacement pattern of skin 90 (e.g., in vicinity of selected location 92) is correlated (or substantially correlated) to the predetermined pressure pattern of the oscillating pressure provided to applicator 110/cavity 112 by pressure generator 120.

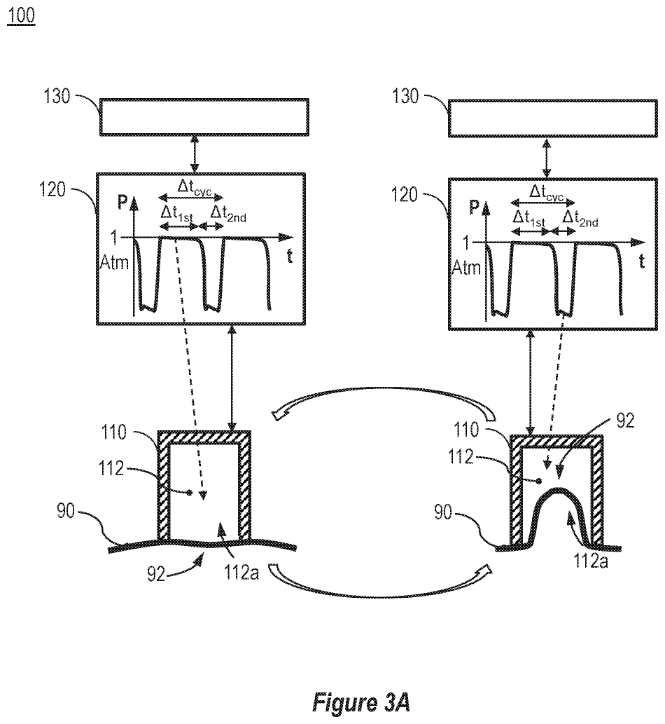

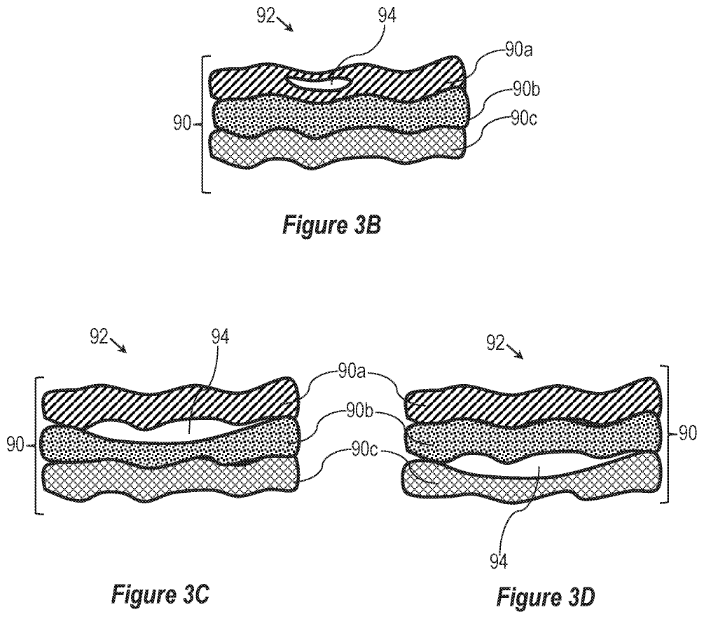

Reference is now made to FIG. 3A, which is a schematic illustration of an example of operation of a device 100 for generating periodic movements of a skin 90 and including a pressure generator 120, according to some embodiments of the invention. Reference is also made to FIGS. 3B, 3C and 3D, which are schematic illustrations of a damage 94 causable to skin layers below a surface skin 90 by a device 100 for generating periodic movements of skin 90, according to some embodiments of the invention.

According to some embodiments, applicator 110 of device 100 is applied to skin 90 at selected location 92 (e.g., as shown in FIG. 3A and as described above with respect to FIGS. 1A and 2A).

Pressure generator 120 may provide oscillating pressure to applicator 110, according to the predetermined pressure pattern (e.g., as described above with respect to FIG. 2A and FIGS. 2B, 2C, 2D, 2E, 2F and 2G).

FIG. 3A shows an example in which the oscillating pressure provided to applicator 110 by pressure generator 120 has square (or substantially square) waveform (e.g., as shown in FIG. 3A and as described above with respect to FIG. 2B).

Yet in the example of FIG. 3A, the oscillating pressure may be achieved by alternately and periodically: (1) reducing the pressure provided to applicator 110 from the first pressure value to the second pressure value at the predetermined pressure drop rate, and (2) increasing the pressure thereof from the second pressure value to the first pressure value at the predetermined pressure rise rate (e.g., as shown in FIG. 3A and as described above with respect to FIG. 2B).

Yet in the example of FIG. 3A, the first pressure value is 1 Atm absolute (e.g., as shown in FIG. 3A), the second pressure value may range between 0.1-0.9 Atm absolute and the predetermined pressure drop rate and/or predetermined pressure rise rate range between 60-600 Atm/sec (as described above with respect to FIGS. 2B-2G).

Accordingly, when the pressure provided to applicator 110 obtains the second pressure value (e.g., during time period Δt_{2nd}), skin At90 (at least in vicinity of selected location 92) is pulled into cavity 112 of applicator 110 (e.g., due to a total negative pressure applied to skin 90) and when the pressure thereof obtains the first pressure value (e.g., during time period Δt₁ₛₜ), skin 90 returns back to its initial (or substantially initial) position (e.g., as shown in FIG. 3A and as described above with respect to FIG. 1B).

It is noted that, in some embodiments, skin 90 may be pushed into skin tissue 90 in vicinity of selected location 92 (e.g., as described below with respect to FIGS. 1C and 1D) by increasing the pressure provided to applicator 110/cavity 112 above 1 Atm absolute.

Controller 130 may control pressure generator 120 to provide multiple oscillating pressure cycles to applicator 110. Accordingly, skin 90 (at least in vicinity of selected location 92) may be repeatedly and periodically moved/displaced according to the specified acceleration/deceleration (e.g., determined by the pressure pattern, as described above with respect to FIGS. 1A and 2A) and at the specified acceleration/deceleration values (e.g., determined by the pressure drop rate and the pressure rise rate, as described above with respect to FIGS. 1A and 2A).

For example, the predetermined pressure drop rate and/or the predetermined pressure rise rate of 60-600 Atm/sec may provide the specified acceleration/deceleration values ranging between 100-6000 m/sec². In some embodiments, the predetermined pressure drop rate and/or the predetermined pressure rise rate of 60-600 Atm/sec provides specified velocity values of movements/displacements of skin 90 ranging between 200-5000 mm/sec.

Repeatedly and periodically movement/displacement of skin 90 according to the specified acceleration/deceleration pattern and/or at the specified acceleration/deceleration values of 100-6000 m/sec² may generate periodic tension/compression forces within and/or between at least some of the layers of skin 90 (at least in vicinity of selected location 92).

For example, the tension/compression forces may be generated within epidermis 90a and/or between epidermis 90a and dermis 90b and/or between dermis 90b and sub-dermis 90c and/or between sub-dermis 90c and adjacent tissue beneath sub-dermis layer 90c. It is noted that epidermis 90a, dermis 90b and sub-dermis 90c are shown schematically in FIGS. 3B, 3C and 3D.

The tension/compression forces between the layers of skin 90 may, for example, generate a damage 94 in at least a portion of skin 90 (e.g., at least in vicinity of selected location 92). Damage 94 may be generated within and/or between at least some of the layers of skin 90. For example, damage 94 may be generated in a depth of 0.5-15 mm below the external surface of skin 90, thereby eliminating (or substantially eliminating) the damage to cells (such as fat cells) and/or other tissues underlying skin 90.

For example, damage 94 may be generated in epidermis 90a (e.g., as shown in FIG. 3B), between epidermis 90a and dermis 90b (e.g., as shown in FIG. 3C), between dermis 90b and sub-dermis 90c (e.g., as shown in FIG. 3D) and/or in any combination thereof.

Damage 94 may, for example, include at least one of: formation of cavitation, formation of blisters, collapse of blisters, formation of tearing and/or formation of separations within and/or between at least some of the layers of skin 90.

In some cases, the tension/compression forces within and/or between the layers of skin 90 may, for example, damage at least a portion of skin tissue 90 without formation of cavitation, formation of blisters, collapse of blisters, formation of tearing and/or formation of separations within and/or between the layers of skin 90.

Damage 94 of skin tissue 90 may, for example, cause controlled local inflammation and/or subsequent induction of collagen and/or induction of skin 90 (e.g., at least in selected location 92). The induction of collagen and/or the induction of skin 90 may, for example, result in rejuvenation of skin 90 (at least in selected location 92) and/or in smoothing of wrinkles on skin 90 (at least in selected location 92).

According to some embodiments, a substance is applied on selected location 92 of skin 90 (e.g., prior to attachment/application of applicator 110 thereto). In some embodiments, the substance is selected from a group consisting of: anesthetic, growth factors, systemic medications, drugs, antibiotics, skin healthcare products (e.g., retin-A) and/or skin infiltration products. In some embodiments, the substance improves the sealing of applicator 110 with selected location 92 on skin 90.

In various embodiments, the frequency of the oscillating pressure provide to applicator 110 is determined to increase permeability of skin 90 and/or to induce penetration of the substance into skin 90. In these cases, device 100 may also be a drug delivery device.

According to some embodiments, device 100 provides a long-term effect of skin rejuvenation due to induction of collagen and/or induction of the skin. In some embodiments, device 100 provides a short-term effect due to a local edema generated by the operation of device 100.

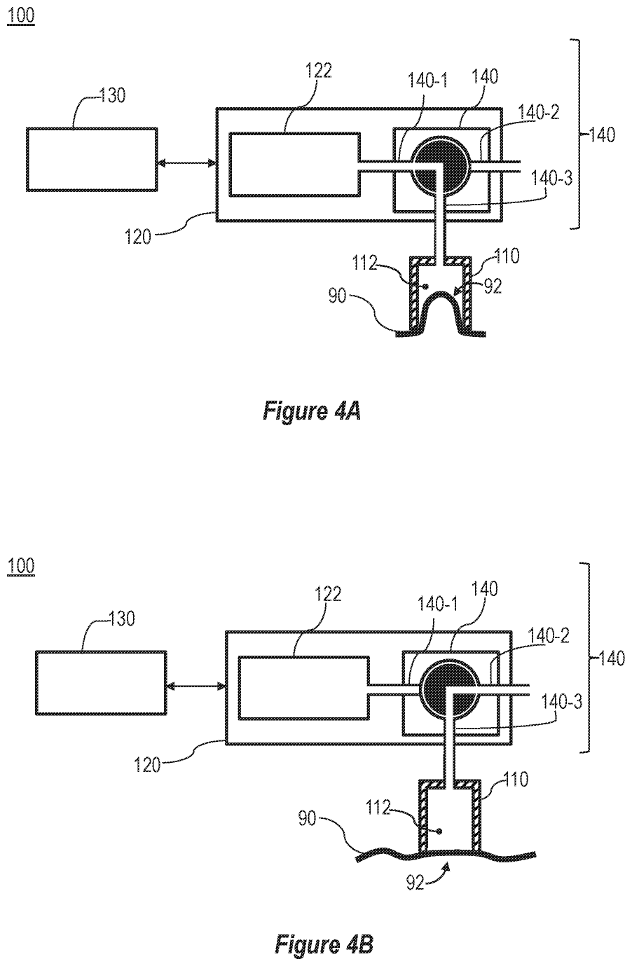

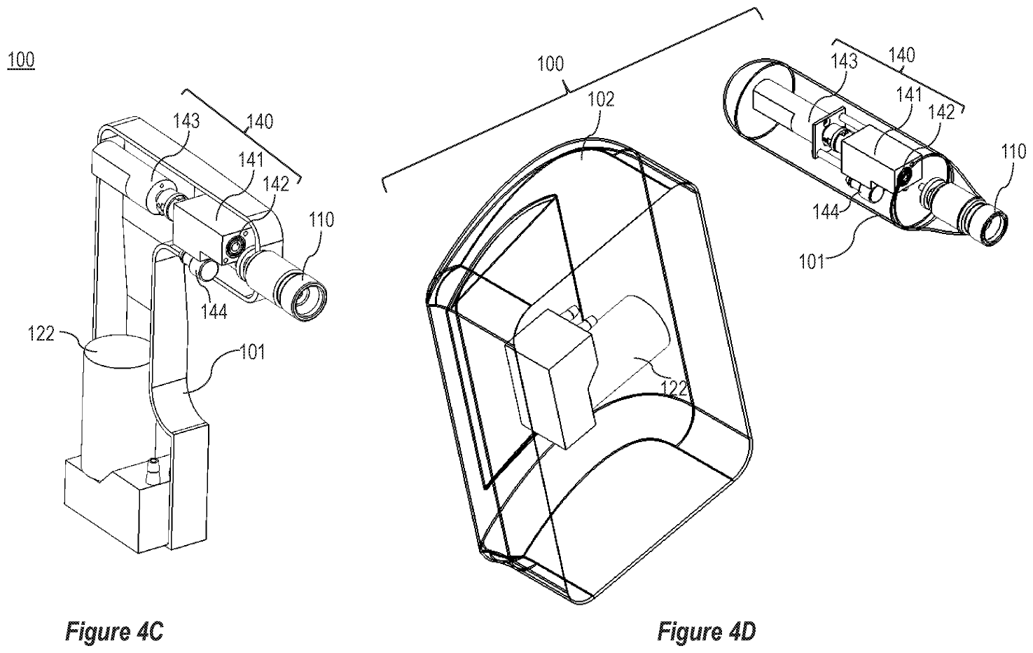

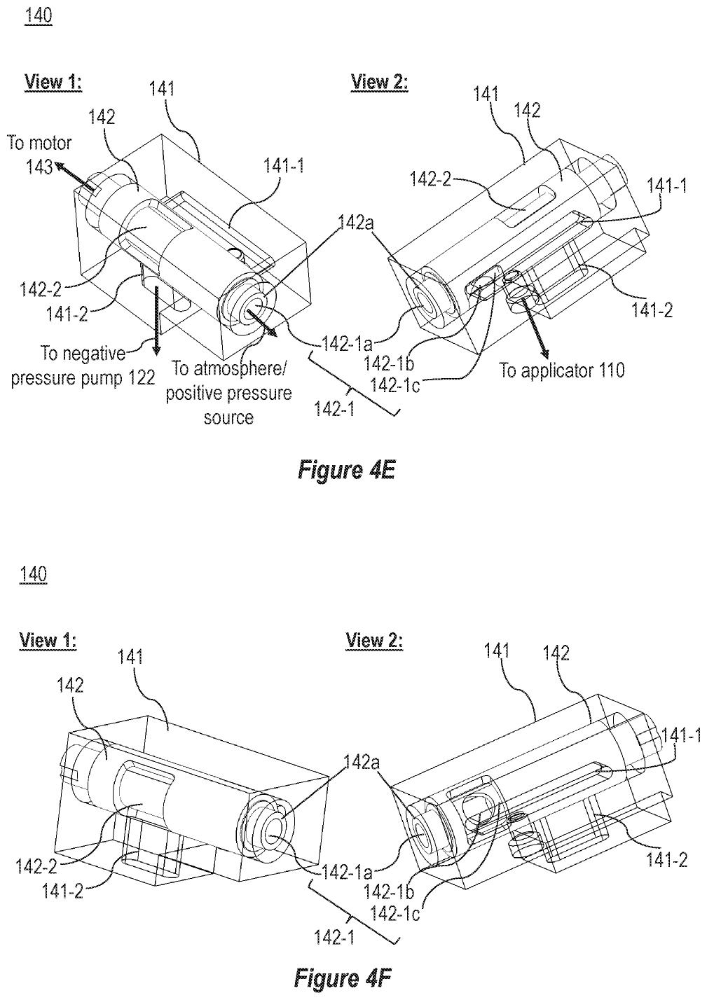

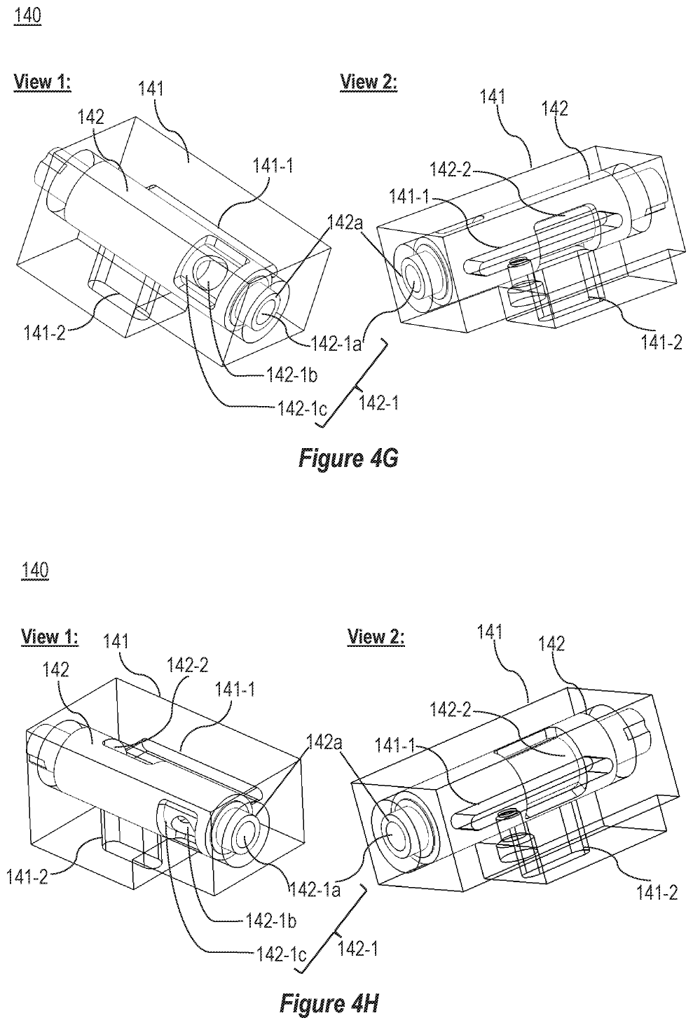

Reference is now made to FIGS. 4A and 4B, which are schematic illustrations of a device 100 for generating periodic movements of a skin 90 and including a vacuum pump 122 and a valve assembly 140, according to some embodiments of the invention.

According to some embodiments, pressure generator 120 includes a vacuum pump 122 and a valve assembly 140.

Valve assembly 140 may be, for example, a 3-way valve. In various embodiments, valve assembly 140 is a mechanical or an electronical valve.

Valve assembly 140 may include a negative pressure inlet 140-1 that may be in fluid communication with vacuum pump 122. Valve assembly 140 may include a positive pressure inlet 140-2. In various embodiments, positive pressure inlet 140-2 may be in fluid communication with an atmosphere (e.g., vent) or with a positive pressure source/pump (not shown). Valve assembly 140 may include an applicator output 140-3 that may be in fluid communication with applicator 110.

Controller 130 may control the operation of valve assembly 140 to provide oscillating pressure to applicator 110/cavity 112. Controller 130 may control valve assembly 140 to alternately and periodically connect applicator 110/cavity 112 to vacuum pump 122 and to atmosphere/positive pressure source to thereby pull skin 90 in vicinity of selected location 92 into cavity 92 and push/release skin 90 away from cavity 112 back to its initial position, as shown in FIGS. 4A and 4B, respectively.

Valve assembly 140 and controller 130 may be configured to provide oscillating pressure according to the predetermined pressure pattern and/or with the predetermined pressure drop rate and/or the predetermined pressure rise rate to thereby periodically accelerate/decelerate skin 90 (in vicinity of selected location 92) at the specified acceleration/deceleration values (e.g., as described above with respect to FIGS. 1A and 3A).

Reference is now made to FIGS. 4C and 4D, which are schematic illustrations of a more detailed aspect of a device 100 for generating periodic movements of a skin 90 and including a valve assembly 140, according to some embodiments of the invention.

According to some embodiments, device 100 includes a housing 101 (e.g., as shown in FIGS. 4C and 4D). In some embodiments, housing 101 accommodates applicator 110, pressure generator 120, vacuum pump 122 and valve assembly 140 (e.g., as shown in FIG. 4C). Housing 101 may be hand-held (e.g., as shown in FIGS. 4C and 4D).

In some embodiments, device 100 includes a vacuum pump housing 102. Vacuum pump housing 102 may accommodate vacuum pump 122 (e.g., as shown in FIG. 4D).

It is noted that fluid communications between applicator 110 and/or vacuum pump 122 and/or valve assembly 140 are not shown in FIGS. 4C and 4D for sake of clarity and that the fluid communications thereof may be any fluid communications known in the art (e.g., rigid/flexible conduits, etc.).

According to some embodiments, valve assembly 140 includes a valve housing 141 that is arranged to accommodate a rotational valve 142 (e.g., as shown in FIGS. 4C and 4D). Valve assembly 140 may further include a valve motor 143. Valve motor 143 may rotate valve 142 within valve housing 141. Controller 130 (not shown in FIGS. 4C and 4D for sake of clarity) may control the rotation of valve 142 by valve motor 143.

Valve housing 141, valve 142 and/or rotation of valve 142 by valve motor 143 may be arranged/configured to provide oscillating pressure having the predetermined pressure pattern and/or the predetermined pressure drop rate and/or the predetermined pressure rise rate, to periodically accelerate/decelerate skin 90 at the specified acceleration/deceleration values—as described below with respect to FIGS. 4E, 4F, 4G and 4H.

Reference is now made to FIGS. 4E, 4F, 4G and 4H, which are schematic illustrations of different operational positions of a valve assembly 140 during an operational cycle of a device 100 for generating periodic movements of a skin 90, according to some embodiments of the invention.

In some embodiments, valve housing 141 accommodates valve 142 in a way that enables rotation of valve 142 (e.g., by valve motor 143) about a central longitudinal axis of valve 142. Valve 142 may, for example, have a cylindrical (or substantially cylindrical) shape (e.g., as shown in FIGS. 4E, 4F, 4G and 4H).

In some embodiments, valve housing 141 includes a nozzle chamber 141-1 in fluid communication (e.g., through a nozzle 144—shown in FIGS. 4C and 4D) with applicator 110. In some embodiments, valve housing 141 includes a negative pressure input 141-2 in fluid communication with vacuum pump 122.

In some embodiments, valve 142 includes a positive pressure input 142-1 in fluid communication with nozzle chamber 141-1 and in fluid communication with an atmosphere/positive pressure source. Positive pressure input 142-1 may be formed by, for example, a cut extending between a valve end 142a of valve 142 and a predetermined position on lateral surface of valve 142 adjacent to valve end 142a thereof. Positive pressure input 142-1 may have a first positive pressure inlet opening 142-1a at valve end 142a and a second positive pressure inlet opening 142-1b (e.g., positioned within a second positive pressure inlet opening dent 142-1c) on the lateral surface of valve 142.

In some embodiments, valve 142 includes a negative pressure chamber 142-2. Negative pressure chamber 142-2 may be, for example, a cut/dent on a lateral surface of cylindrical body of valve 142. Negative pressure chamber 142-2 may be positioned at an opposite side (or at substantially opposite side) of the lateral surface of valve 142 with respect to second positive pressure inlet opening 142-1b.

FIGS. 4E, 4F, 4G and 4H show different operational positions of valve 142 with respect to valve housing 141 during an operational cycle of device 100, as described below.

In a first operation position shown in FIG. 4E, nozzle chamber 141-1 is in communication with an atmosphere/positive pressure source through positive pressure inlet 142-1. In this position, the pressure provided to applicator 110 has the first pressure value.

In a second operational position shown in FIG. 4F, nozzle chamber 141-1 is in communication with an atmosphere/positive pressure source through positive pressure inlet 142-1 and negative pressure chamber 142-2 is in communication with negative pressure source 122 through negative pressure input 141-2. In this position, the pressure within negative pressure chamber begins to drop from the first pressure value to the second pressure value.

In a third operational position shown in FIG. 4E, nozzle chamber 141-1 is in communication with negative pressure chamber 142-2. In this position, the pressure in nozzle chamber 141-1 and, accordingly, the pressure provided to applicator 110 drops from the first pressure value to the second pressure value at the predetermined pressure drop rate of, for example, 60-600 Atm/sec.

In a fourth operational condition shown in FIG. 4H, nozzle chamber 141-1 is still in communication with negative pressure chamber 142-2 and the pressure within nozzle chamber 141-1 and the pressure provided to applicator 110 is maintained on the second pressure value.

Once valve 142 is rotated (by valve motor 143) to the first operational position (e.g., as shown in FIG. 4E), the pressure within nozzle chamber 141-1 and the pressure provide to applicator 110 increases from the second pressure value to the first pressure value.

In some embodiments, rotational velocity of valve motor 143 changes during an operational cycle of valve assembly 140. For example, in transition between the second operational position (described above with respect to FIG. 4F) and the third operational position (described above with respect to FIG. 4G), valve motor 143 may rotate at a first rotational speed value and during the rest of the operational cycle valve motor 143 may rotate at a second rotational speed value. In various embodiments, rotation of valve motor 143 at different rotational velocities during the operational cycle determines the pressure drop rate and/or the pressure rise rate without changing the RPM of the motor.

Predetermined parameters of various elements of valve assembly 140 may be determined to provide the desired waveform and/or the predetermined pressure drop rate values and/or the predetermined pressure rise rate values of the pressure provided to applicator 110. The predetermined parameters may, for example, include shape, dimensions and relative positions of the various elements of valve assembly 140 with respect to each other. The various elements of valve assembly 140 may, for example, include nozzle chamber 141-1, negative pressure inlet 141-2, positive pressure outlet 142-1 and/or negative pressure chamber 142-2.

For example, valve assembly 140 (e.g., described above with respect to FIGS. 4C-4H) may provide square (or substantially square) waveform of the pressure provided to applicator 120 with the predetermined pressure drop rate and/or the predetermined pressure rise rate of 60-600 Atm/sec. Accordingly, valve assembly 140 may be capable to provide periodic movement/displacement of skin 90 at the specified acceleration/deceleration values of 100-6000 m/sec².

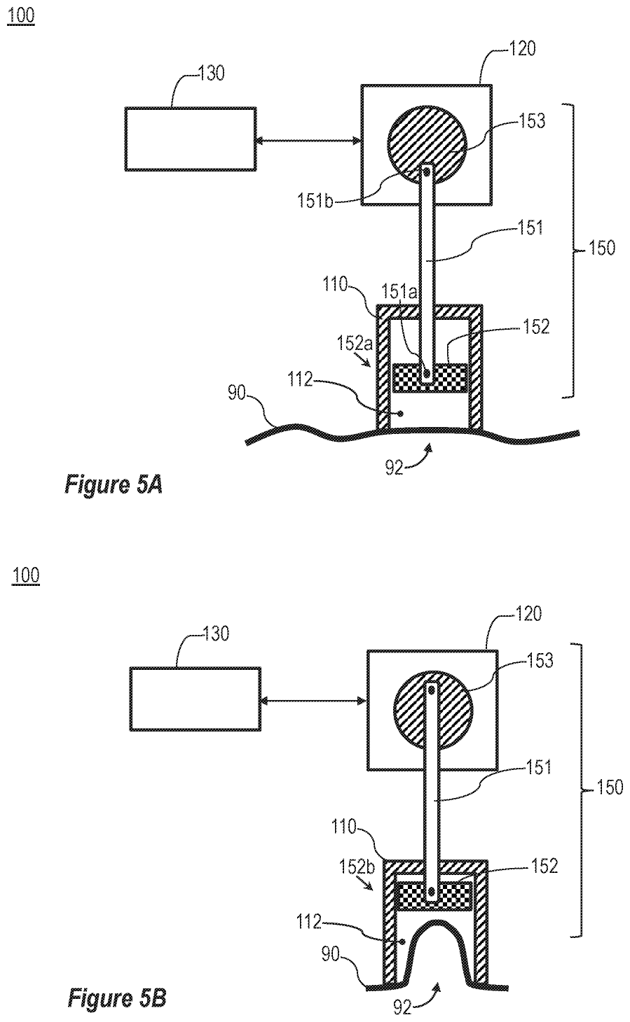

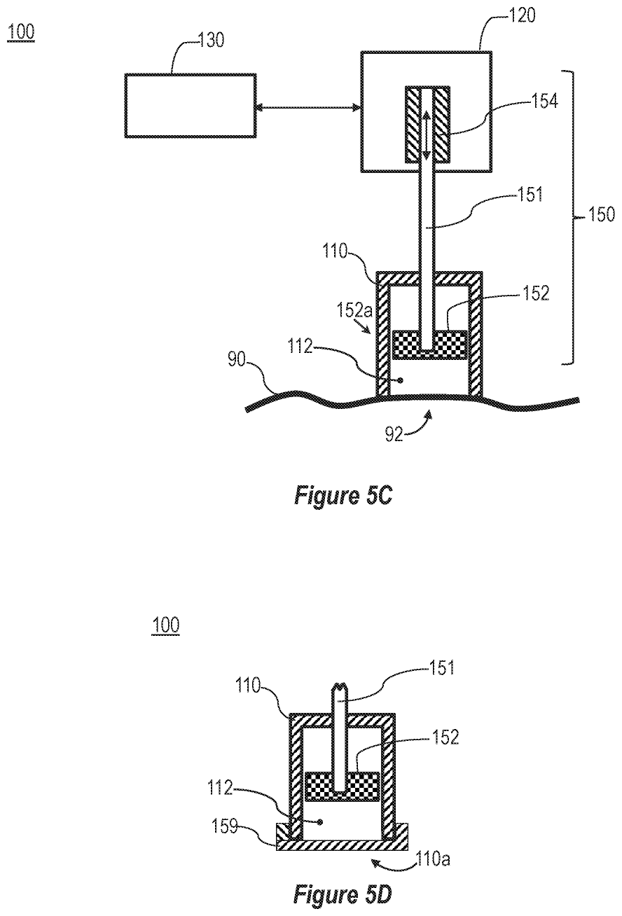

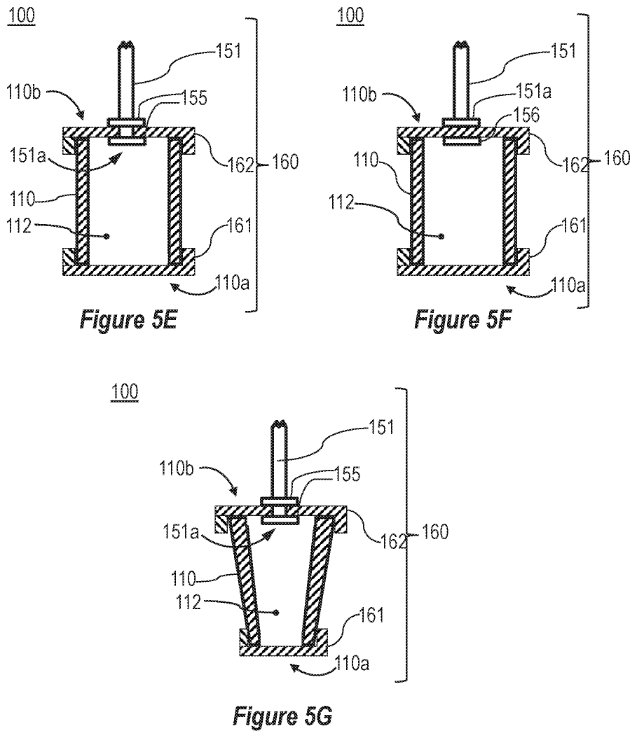

Reference is now made to FIGS. 5A, 5B, 5C and 5D, which are schematic illustrations of a device 100 for generating periodic movements of a skin 90 and including a pressure generator 120 with a movable piston assembly 150, according to some embodiments of the invention.

According to some embodiments, pressure generator 120 includes a movable piston assembly 150. Movable piston assembly 150 may include a shaft 151 having a first shaft end 151a and a second shaft end 151b. Piston assembly 150 may include a piston 152 attached (or rotatably attached) to shaft 151 at first shaft end 151a and arranged to move within cavity 112 of applicator 110.

According to some embodiments, movable piston assembly includes a shaft motor 153. Shaft 151 may be attached (or rotatably attached) to shaft motor 153, for example, adjacent to an outer edge of motor 153. Rotation of shaft motor 153 may move shaft 151 and piston 152 between a first piston position 152a (e.g., as shown in FIG. 5A) and a second piston position 152b (e.g., as shown in FIG. 5B) and back from second piston position 152b to first piston position 152a, thereby providing oscillating pressure within applicator 110/cavity 112.

For example, when piston 152 is moved from first piston position 152a to second piston position 152b, negative pressure is generated within cavity 112 of applicator 110, which pulls skin 90 (e.g., in vicinity of selected location 92) into cavity 112 (e.g., as shown in FIG. 5A). When piston 152 is moved back from second piston position 152b to first piston position 152a, the pressure within cavity 112 returns back to its initial value, which pushes back the skin 90 (e.g., in vicinity of selected location 92) back to its initial position (e.g., as shown in FIG. 5A).

Periodic movements of piston 152 between first piston position 152a and second piston position 152b and back is configured to provide oscillating pressure having the predetermined pressure patterns (e.g., sinusoidal pressure pattern), and thereby periodically move/displace skin 90 (e.g., in vicinity of selected location 92) according to the specified acceleration/deceleration patterns and/or at the specified acceleration/deceleration values (e.g., as described above with respect to FIGS. 1A, 2A and 3A).

In some embodiments, movements of piston 152 between first piston position 152a and second piston position 152b and back alternately and periodically change the pressure within applicator 110/cavity 112 between the first pressure value and the second pressure value at the predetermined pressure drop rate and between the second pressure value and the first pressure value at the predetermined pressure rise rate (e.g., as described above with respect to FIGS. 2A and 3A).

For example, controller 130 may control the rotation of shaft motor 153 to provide the predetermined pressure drop rate and/or the predetermined pressure rise rate of 60-600 Atm/sec. Rotation of shaft motor 153 at, for example, 10-100 RPM may, for example, provide the predetermined pressure drop rate and/or the predetermined pressure rise rate of 60-600 Atm/sec. Accordingly, rotation of shaft motor 153 at, for example, 100-1000 RPM may provide periodic movements/displacements of skin 90 (e.g., in vicinity of selected location 92) at the specified acceleration values of 100-6000 m/sec².

According to some embodiments, movable piston assembly 150 includes a solenoid/voice coil 154 (e.g., as shown in FIG. 5C). Solenoid 154 is arranged to periodically move piston shaft 151 and piston 152 attached thereto between first piston position 152a and second piston position 152b and back (e.g., as described above with respect to FIGS. 5A and 5B).

According to some embodiments, device 100 includes a membrane 159 (e.g., as shown in FIG. 5D). Membrane 159 may be attachable (or removably attachable) to a distal tip 110a of applicator 110. Membrane 159 may be made of flexible elastic material (such as rubber, silicon, latex, etc.) and/or of foldable fabric material. In some embodiments, membrane 159 reduces a hematoma formation at selected location 92 on skin 90. It is noted that membrane 159 may be also used in any of embodiments of device 100, for example those described above with respect to FIGS. 1A, 2A, 3A and 4A-4H.

In some embodiments, cavity 112 of applicator 110 is filled with air. In some embodiments, cavity 112 of applicator 112 is filled with a non-compressible fluid. The non-compressible fluid may, for example, be oil, gel, or any other fluid with a specified boiling point greater than a boiling point of water. Fluids having the specified boiling point may, for example, eliminate generation of cavitation within applicator 110, thereby allowing generation of cavitation within skin 90 (e.g., as described above with respect to FIG. 1A).

Reference is now made to FIGS. 5E, 5F and 5G which are schematic illustrations of a device 100 for generating periodic movements of a skin 90 and including a pressure generator 120 with a diaphragm assembly 160, according to some embodiments of the invention.

It is noted that pressure generator 120 and controller 130 are not shown in FIGS. 5E, 5F and 5G for sake of clarity and that pressure generator 120 and/or controller 130 may be at least partly similar to those described above with respect to FIGS. 5A, 5B, 5C and 5D.

According to some embodiments, diaphragm assembly 160 includes applicator 110 having a hollow interior and membranes 161, 162 attachable to distal end 110a and a proximal end 110b of applicator 110, respectively (e.g., as shown in FIGS. 5E and 5F). Membranes 161, 162 may be similar to membrane 159 described above with respect to FIG. 5D. In various embodiments, cavity 112 formed between walls of applicator 110 and membranes 161, 162 is filled with fluid having the specified boiling point (e.g., as described above with respect to FIG. 5D).

In some embodiments, shaft 151 crosses membrane 162 and is connected at first shaft end 151a to membrane 162 using any mechanical means 155 known in the art.

In various embodiments, first shaft end 151a includes a magnetic material and is connectable to membrane 162 using a metal part 156 attached to membrane 161/positioned within cavity 112.

In various embodiments, connection means 155 and magnetic coupling 151a, 156 enable easy detachment/attachment (e.g., replacement) of applicator 110 to, for example, housing 101 of device 100.

In some embodiments, applicator 110 has non-uniform traverse cross-section along a longitudinal axis of applicator 110. For example, traverse cross-section at proximal end 110b of applicator 110 may be larger than traverse cross-section at distal end 110a of applicator 110 (e.g., as shown in FIG. 5G). In such configuration, relatively small movements of membrane 162 at proximal end 110b of applicator 110 may result in relatively large movements of membrane 161 at distal end 110a of applicator 110 (e.g., as compared to movements of membrane 162).

In some embodiments, membranes 159, 161, 162 have thickness ranging between 0.05-0.5 mm.

According to various embodiments, membrane 159 (e.g., as described above with respect to FIG. 5D) or membranes 161, 162 (e.g., as described above with respect to FIGS. 5E and 5F) are covered with a biocompatible glue. The glue may, for example, adhere membranes 159, 161 to selected location 92 on skin 90 and/or adhere membrane 162 to shaft 151 to thereby provide motion and acceleration/deceleration of skin 90 (in vicinity of selected location 92) upon application of oscillating pressure to applicator 110 (e.g., as described above with respect to FIGS. 5A and 5B). The glue may further enable easy detachment of applicator 110 from skin 90 without damaging the surface of skin 90.

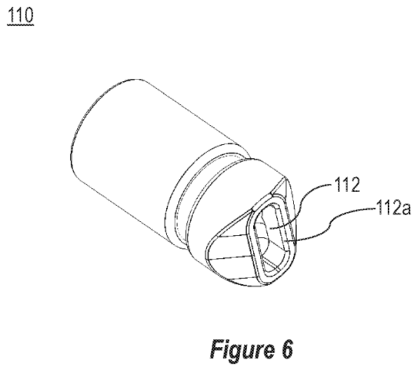

Reference is now made to FIG. 6, which is a schematic illustration of an applicator 110 for a device 100 for generating periodic movements of a skin 90, according to some embodiments of the invention.

According to various embodiments, applicator 110 has different shapes (e.g., circular, rectangular, etc.). For example, FIG. 6 shows applicator 110 with substantially oval opening 112a of cavity 112. It is noted that shape and dimensions of applicator 110 may be determined based on a desired location of application of device 100.

In some embodiments, applicator 110 is removably attachable to housing 101 of device 100. In some embodiments, applicator 110 is disposable.

Reference is now made to FIG. 7, which is a schematic illustration of a device 100 for generating periodic movements of a skin 90 and including a mechanical movements assembly 170, according to some embodiments of the invention.

According to some embodiments, mechanical movements generator 120 includes a mechanical movements assembly 170. Mechanical movements assembly 170 may include a shaft 172 and a solenoid/voice coil 174.

Applicator 110 may be adherable (e.g., using a biocompatible glue) to skin 90 at selected location 92 and may include connection means 114.

Shaft 172 may have a first shaft end 172a and a second shaft end 172b. Shaft 172 may be removably connectable at first shaft end 172a to applicator 110 using connection means 114. Shaft 172 may be coupled to solenoid/voice coil 174 at second shaft end 172b.

Controller 130 may control solenoid/voice coil 174 to periodically move/displace shaft 172 and applicator 110 connected thereto according to according to the specified acceleration/deceleration pattern and/or at the specified acceleration/deceleration values (e.g., as described above with respect to FIG. 1A and FIGS. 1B, 1C and 1D).

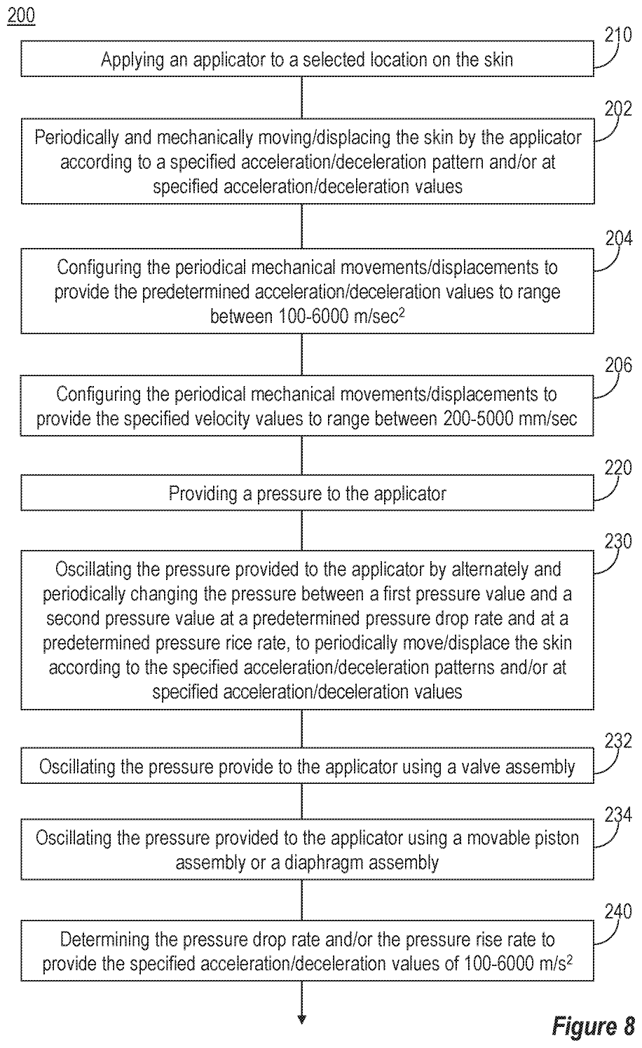

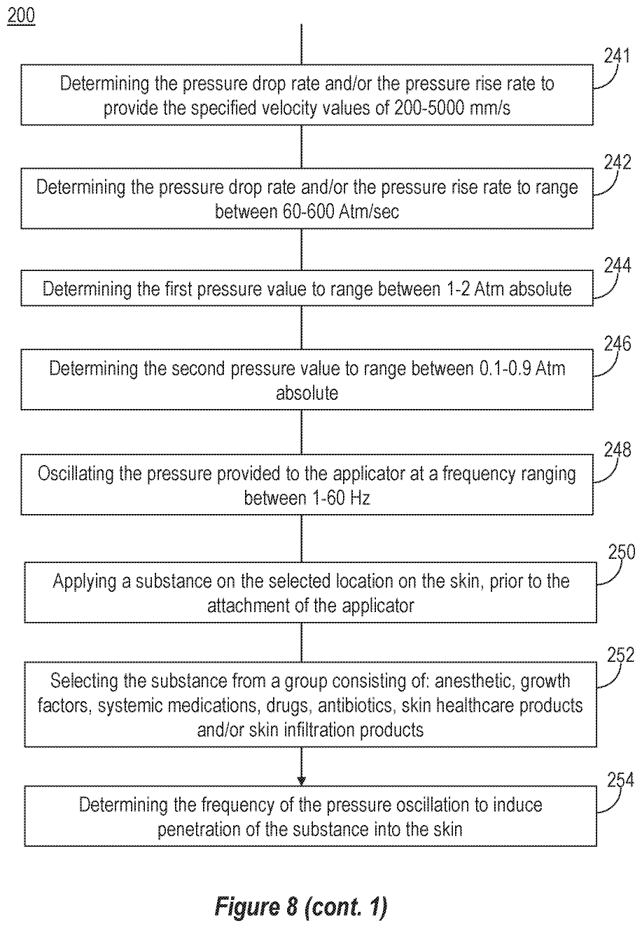

Reference is now made to FIG. 8, which is a flowchart of a method 200 of generating periodic movements of a skin, according to some embodiments of the invention.

Method 200 may be implemented by device 100, which may be configured to implement method 200. It is noted that method 200 is not limited to the flowcharts illustrated in FIG. 8 and to the corresponding description. For example, in various embodiments, method 200 needs not move through each illustrated box or stage, or in exactly the same order as illustrated and described.

According to some embodiments, method 200 includes applying an applicator to a selected location on the skin (stage 210). For example, applicator 110 as described above with respect to FIGS. 1A, 2A, 3A, 4A-4D, 5A-5D, 5E-5G, 6 and 7.

According to some embodiments, method 200 includes periodically and mechanically moving/displacing the skin by the applicator according to a specified acceleration/deceleration pattern and/or at specified acceleration/deceleration values (stage 202) (e.g., as described above with respect to FIGS. 1A, 2A, 3A, 4A-4H, 5A-5G and 7).

In some embodiments, method 200 includes configuring the periodic mechanical movements/displacements to provide the specified acceleration/deceleration values to range between 100-6000 m/sec² (stage 204) (e.g., as described above with respect to FIGS. 1A, 2A, 3A, 4A-4H, 5A-5D, 5E-5G and 7).

In some embodiments, method 200 includes configuring the periodic mechanical movements/displacements to provide specified velocity values of periodic movements/displacements of the skin to range between 200-5000 mm/sec (stage 206).

According to some embodiments, method 200 includes providing a pressure to the applicator (stage 220). For example, the pressure may be provided to the applicator by pressure generator 120 (e.g., as described above with respect to FIGS. 2A and 3A), valve assembly 140 (e.g., as described above with respect to FIGS. 4A-4H), movable piston assembly 150 (e.g., as described above with respect to FIGS. 5A-5D) or diaphragm assembly 160 (e.g., as described above with respect to FIGS. 5E-5G).

According to some embodiments, method 200 includes oscillating the pressure provided to the applicator by alternately and periodically changing the pressure between a first pressure value and a second pressure value at a predetermined pressure drop rate and between the second pressure value and the first pressure value at a predetermined increase pressure rate, to periodically move/displace the skin (e.g., at least in a vicinity of the selected location) according to the specified acceleration/deceleration patterns and/or at the specified acceleration/deceleration values (stage 230) (e.g., as described above with respect to FIGS. 1A, 2A-2F, 3A, 4A-4H and 5A-5G).

In some embodiments, method 200 further includes oscillating the pressure provided to the applicator using a valve assembly (stage 232) (e.g., as described above with respect to FIGS. 4A-4H).

In some embodiments, method 200 further includes oscillating the pressure provided to the applicator using a movable piston assembly or diaphragm assembly (stage 234) (e.g., as described above with respect to FIGS. 5A-5D and FIGS. 5E-5G, respectively).

In some embodiments, method 200 further includes determining the pressure drop rate and/or the pressure rise rate to provide the specified acceleration/deceleration values of 100-6000 m/s² (stage 240).

In some embodiments, method 200 further includes determining the pressure drop rate and/or the pressure rise rate to provide the specified velocity values of 200-5000 mm/s (stage 241).

In some embodiments, method 200 further includes determining the pressure drop rate and/or the pressure rise rate to range between 60-600 Atm/sec (stage 242) (e.g., as described above with respect to FIGS. 2A, 3A, 4A-4H and 5A-5G).

In some embodiments, method 200 further includes determining the first pressure value to range between 1-2 Atm absolute (stage 244) (e.g., as described above with respect to FIGS. 2B-2G).

In some embodiments, method 200 further includes determining the second pressure value to range between 0.1-0.9 Atm absolute (stage 246) (e.g., as described above with respect to FIGS. 2B-2G).

In some embodiments, method 200 further includes oscillating the pressure provided to the applicator at a frequency ranging between 1-60 Hz (stage 248) (e.g., as described above with respect to FIGS. 2B-2G).

In some embodiments, method 200 further includes applying a substance on the selected location on the skin, prior to the attachment of the applicator (stage 250) (e.g., as described above with respect to FIG. 3A).

In some embodiments, method 200 further includes selecting the substance from a group consisting of: anesthetic, growth factors, systemic medications, drugs, antibiotics, skin healthcare products and/or skin infiltration products (stage 252) (e.g., as described above with respect to FIG. 3A).

In some embodiments, method 200 further includes determining the frequency of the pressure oscillation to induce penetration of the substance into the skin (stage 254) (e.g., as described above with respect to FIG. 3A).

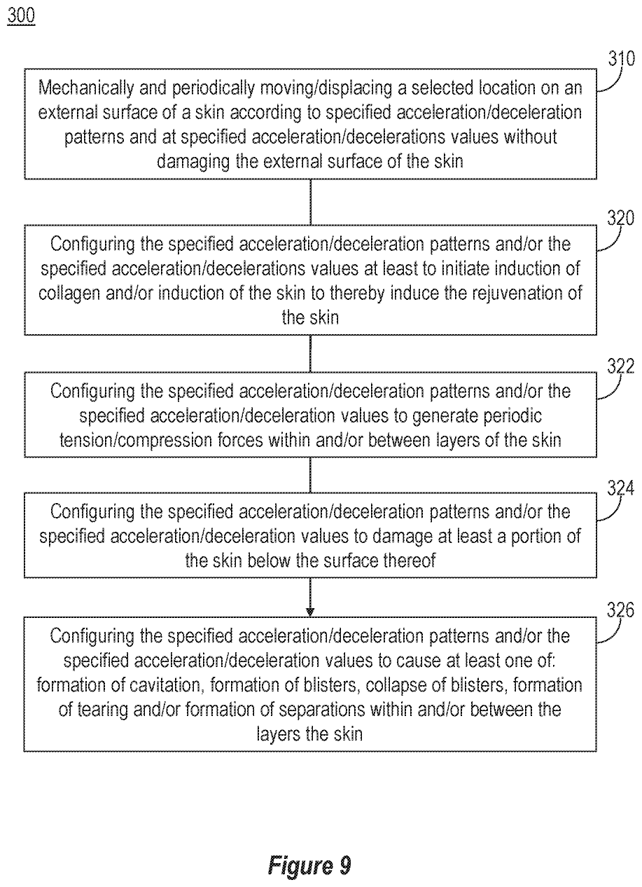

Reference is now made to FIG. 9, which is a flowchart of a method 300 of a rejuvenation of a skin, according to some embodiments of the invention.

Method 300 may be implemented by device 100, which may be configured to implement method 300. It is noted that method 300 is not limited to the flowcharts illustrated in FIG. 9 and to the corresponding description. For example, in various embodiments, method 300 needs not move through each illustrated box or stage, or in exactly the same order as illustrated and described.

According to some embodiments, method 300 includes mechanically and periodically moving/displacing a selected location on an external surface of a skin according to specified acceleration/deceleration patterns and/or at specified acceleration/decelerations values, without damaging (or substantially without damaging) the external surface of the skin (stage 310) (e.g., as described above with respect to FIGS. 1A, 2A, 2B-2G, 3A, 4A-4H, 5A-5D, 5E-5G and 7).

According to some embodiments, method 300 includes configuring the specified acceleration/deceleration patterns and/or the specified acceleration/decelerations values at least to initiate induction of collagen and/or induction of the skin to thereby induce the rejuvenation of the skin (stage 320) (e.g., as described above with respect to FIG. 3A).

In some embodiments, method 300 further includes configuring the specified acceleration/deceleration patterns and/or the specified acceleration/deceleration values to generate periodic tension/compression forces within and/or between at least some of the layers of the skin (stage 322) (e.g., as described above with respect to FIG. 3A).

In some embodiments, method 300 further includes configuring the specified acceleration/deceleration patterns and/or the specified acceleration/deceleration values to damage at least a portion of the skin below the surface thereof (stage 324) (e.g., as described above with respect to FIG. 3A).

In some embodiments, method 300 further includes configuring the specified acceleration/deceleration patterns and/or the specified acceleration/deceleration values to cause at least one of: formation of cavitation, formation of blisters, collapse of blisters, formation of tearing and/or formation of separations within and/or between the layers the skin (stage 326) (e.g., as described above with respect to FIG. 3A).

Advantageously, the disclosed devices and methods may enable non-invasive periodic movements of the skin without damaging (or substantially without damaging) the external surface of the skin. Furthermore, the disclosed devices and methods may enable non-invasive rejuvenation of the skin, while eliminating a need in painful thermal and/or chemical procedures of skin rejuvenation.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1-18. (canceled)

19. A device far generating periodic movements of a skin, the device comprising:
an applicator applicable to a selected location on the skin;
a mechanical movements generator coupled to the applicator and arranged to periodically and mechanically move/displace the skin using the applicator and according to a specified acceleration/deceleration pattern and at specified acceleration/deceleration values ranging between 100-6000 m/sec²; and
a controller coupled to the mechanical movements generator and configured control the mechanical movements/displacements of the skin by the applicator.

20. The device of claim 19, wherein the mechanical movements generator is a pressure generator arranged to provide a pressure to the applicator and to oscillate: the pressure provided to the applicator pressure between a first pressure value and a second pressure value at a predetermined pressure drop rate and between the second pressure value and the first pressure value at a predetermined pressure rise rate, to thereby periodically and mechanically move/displace the skin, wherein the predetermined pressure drop rate ranges between 60-600 Atm/sec.

21. The device, of claim 20, wherein the pressure generator comprises:
a vacuum pump; and
a valve assembly comprising:
a cylindrical valve body comprising:
a positive pressure inlet formed by a cut made within the cylindrical valve body extending between a first positive pressure inlet opening on one end of the cylindrical valve body and a second positive pressure inlet opening on a lateral surface of the cylindrical valve: body and at a predetermined distance from the end thereof, the second positive pressure: inlet opening is disposed within a second positive pressure inlet opening dent made on the lateral surface of the: cylindrical valve body: and
a negative pressure chamber made by a cut on the literal surface of the cylindrical valve body, the negative pressure chamber is opposite to the second positive pressure inlet opening dent;
a valve: housing adapted to accommodate the: cylindrical valve body and to enable rotation of the cylindrical valve body about a central longitudinal axis of the cylindrical valve: body, the valve housing comprising:
a nozzle chamber in fluid communication with the applicator through a nozzle; and
a negative: pressure: inlet in fluid communication with tine vacuum pump; and
a valve motor controllable by the controller and adapted to rotate the cylindrical valve body.

22. The device of claim 21, wherein the first positive pressure inlet opening, second positive pressure inlet opening, the second. positive pressure inlet opening dent, the nozzle chamber and the negative pressure inlet are shaped, sized and positioned with respect to each other such that during each rotational cycle of the cylindrical valve body:
the nozzle chamber is in fluid communication with one of atmosphere and a positive pressure source through the positive pressure inlet during a first predetermined. time interval to provide the first pressure value to the applicator;
the nozzle chamber is in fluid communication with one of atmosphere and the positive pressure source through the positive pressure inlet and the negative pressure chamber is in fluid communication with the negative pressure source through the negative pressure inlet during a second predetermined time interval to initiate the drop of the pressure provided to the applicator form the first pressure value to the second pressure value;
the nozzle chamber is in fluid communication with the negative pressure chamber during a third predetermined time interval to drop the ^{.}pressure provided to the applicator from the first pressure value to the second pressure value at the pressure drop rate ranging between 60-600 Atm/sec and to maintain the pressure provided to the applicator at the second pressure value; and
the nozzle chamber is back to fluid communication with one of atmosphere and the positive pressure source through the positive pressure inlet to rise pressure provided to the applicator from the second pressure value to the first pressure value at the pressure rise rate ranging between 60-600 Atm/sec.

23. The device of claim 22, wherein the controller is configured to control rotation of the cylindrical valve: body by the valve motor such that the cylindrical valve body rotates:
at a first rotational speed. value during a time interval ranging between the second predetermined time interval and the third predetermined time interval; and
at a second rotational speed value during the rest of the rotational cycle;
to thereby define at least one of the: pressure drop rate and the pressure rise rate without changing the RPM of the valve motor.

24. The device of claim 20, wherein the first pressure value ranges between 1-2 Atm absolute,

25. The device of claim 20, wherein the se and pressure value ranges between 0.1-0.9 Atm absolute.

26. The device of claim 20, wherein the pressure generator oscillates the pressure provided to the applicator at a frequency ranging between 1-60 Hz.

27. The device of claim 19, further comprising a membrane arranged to cover a portion of the applicator that is attachable to the skin.

28. A method of generating periodic movements of a skin, the method comprising:
applying an applicator to a selected location on the skin; and
periodically and mechanically moving/displacing the skin by the applicator according to a specified acceleration/deceleration pattern and at specified acceleration/deceleration values raging between 100-6000 m/sec²,

29. The method of claim 28, further comprising;
providing a pressure to the applicator; and
oscillating the pressure provided to the applicator by alternatively and periodically changing the pressure between a first pressure value and a second pressure value at a predetermined pressure drop rate and between the second pressure value and the first pressure value at a predetermined pressure rise rate, to thereby periodically and mechanically move/displace the skin;
wherein the predetermined pressure drop rate ranges between 60-600 Atm/sec pressure rise rate.

30. The method of claim 28, further comprising/determining the first pressure value to range between 1-2 Atm absolute.

31. The method of claim 28, further comprising determining the second pressure value to range between 0.1-0.9 Atm absolute.

32. The method of claim 28, further comprising oscillating the pressure provided to the applicator at a frequency ranging between 1-60 Hz.

33. The method of claim 29, further comprising generating the pressure provided to applicator by a valve assembly capable to provide the oscillating pressure having the predetermined pressure drop rate and the predetermined pressure rise rate ranging between 60-600 Atm/sec.

34. The method of claim 28, further comprising applying a substance on the selected location on the skin, wherein the substance is selected from a group consisting of: anesthetic, growth factors, systemic medications, drugs, antibiotics, skin healthcare products and skin infiltration products.

35. A method of a rejuvenation of a skin, the method comprising mechanically and periodically moving/displacing a selected location on an external surface of a skin according to a specified acceleration/deceleration pattern and at specified acceleration/decelerations values without damaging the external surface of the skin, wherein the specified acceleration/deceleration pattern and the specified acceleration/deceleration values are configured at least to initiate induction of collagen and/or induction of the skin to thereby induce the rejuvenation of the skin.

36. The method of claim 35, further comprising configuring the specified acceleration/deceleration pattern and the specified acceleration/deceleration values to generate periodic tension/compression forces within or between at least some of the layers of the skin.

37. The method of claim 35, further comprising configuring the specified acceleration/deceleration pattern and the specified acceleration/deceleration values to damage at least a portion of the skin below the surface thereof.

38. The method of claim 35, further comprising configuring the specified acceleration/deceleration pattern and configuring the specified acceleration/deceleration values to cause at least one of: formation of cavitation, formation of blisters, collapse of blisters, formation of tearing and formation of separations within or between at least some of the layers the skin.
